(19) United States
(12) Patent Application Publication
(10) Pub. No.: US 2024/0159625 A1
(43) Pub. Date: May 16, 2024

(54) TEST APPARATUS FOR A VEHICLE

(71) Applicant: Ford Global Technologies, LLC, Dearborn, MI (US)

(72) Inventors: Timothy Pistole, Grosse Ile, MI (US); Mark Thomas Weston, Livonia, MI (US)

(73) Assignee: Ford Global Technologies, LLC, Dearborn, MI (US)

(21) Appl. No.: 18/418,925

(22) Filed: Jan. 22, 2024

Related U.S. Application Data
(63) Continuation-in-part of application No. 17/531,188, filed on Nov. 19, 2021, now Pat. No. 11,898,935.

(51) Int. Cl. G01M 17/007; G01M 15/05

(52) U.S. Cl. CPC G01M 17/0072; G01M 15/05

(57) ABSTRACT

A test apparatus for simulating off-road conditions for a motor vehicle includes a platform, front and rear roller assemblies, a driveshaft and at least one resistance assembly. Each of the front roller assembly and the rear roller assembly is coupled to the platform and configured to receive a pair of wheels of the motor vehicle. The driveshaft is secured between the front roller assembly and the rear roller assembly and configured to transmit rotary power from one of the front roller assembly and the rear roller assembly to the other of the front roller assembly and the rear roller assembly. Each resistance assembly is coupled to at least one of the front and rear roller assemblies and is configured to vary a resistance of the at least one of the front and rear roller assemblies. An orientation of the platform is adjustable.

### CROSS-REFERENCE TO RELATED APPLICATION

This application is a continuation-in-part of and claims the benefit of U.S. application Ser. No. 17/531,188, filed Nov. 19, 2021, and titled “TEST APPARATUS FOR SIMULATING OFF-ROAD CONDITIONS FOR A VEHICLE”, the contents of which are incorporated herein by reference in its entirety.

### FIELD

The present disclosure relates to a test apparatus for a vehicle, and more specifically to a test apparatus for simulating off-road conditions.

### BACKGROUND

The statements in this section merely provide background information related to the present disclosure and may not constitute prior art.

Some vehicles such as pick-up trucks, for example, are capable of off-road driving. Such vehicles capable of off-road driving are typically tested in the field such as parks, for example, to provide for a variety of vehicle operating conditions that a vehicle operator is likely to encounter while driving off-road. Testing the vehicle in the field where the vehicle is outside may be less desirable for the original equipment manufacture (OEM). For example, when testing off-road vehicles having undisclosed technology in the field, the undisclosed technology runs the risk of being revealed by photographs taken by the viewing public. In another example, when testing off-road vehicles in the field, it is often difficult for repeatability of tests due to constant changes in the weather.

These issues related to testing of vehicles having off-road capabilities, among other issues related to such vehicles, are addressed by the present disclosure.

### SUMMARY

This section provides a general summary of the disclosure and is not a comprehensive disclosure of its full scope or all of its features.

In one form, the present disclosure provides a test apparatus for simulating off-road conditions for a motor vehicle that includes a platform, front and rear roller assemblies, a driveshaft, and at least one resistance assembly. The front and rear roller assemblies are coupled to the platform. Each of the front roller assembly and the rear roller assembly is configured to receive a pair of wheels of the motor vehicle. The driveshaft is secured between the front roller assembly and the rear roller assembly and is configured to transmit rotary power from one of the front roller assembly and the rear roller assembly to the other of the front roller assembly and the rear roller assembly. The resistance assembly is coupled to at least one of the front and rear roller assemblies and configured to vary a resistance of the at least one of the front and rear roller assemblies. An orientation of the platform is adjustable.

In variations of the test apparatus of the above paragraph, which can be implemented individually or in any combination: the at least one resistance assembly is secured to the platform; the at least one resistance assembly is located outside of the platform; each of the front roller assembly and the rear roller assembly includes first and second roller devices, each of the first and second roller devices configured to receive a respective wheel of the pair of wheels; an axle secured to and between the first and second roller devices; each of the first and second roller devices includes a first drum fixed for rotation with the axle; a second drum configured to be fixed for rotation with a drum axle; a transmission element meshingly engaged with the axle and configured to be meshingly engaged with the drum axle, the transmission element configured to transmit rotatory power from the first drum to the second drum; the resistance assembly is engaged with the transmission element; a brake assembly associated with each of the first and second roller devices; the orientation includes roll, pitch, yaw, and combinations thereof; a crane; a plurality of suspension devices, each suspension device secured at a first end to a respective corner of the platform and at a second end to the crane, the crane is configured to adjust the orientation of the platform; and the resistance assembly includes a plurality of resistance assemblies, the plurality of resistance assemblies are operable independent of each other.

In another form, the present disclosure provides a test apparatus for simulating off-road conditions for a motor vehicle that includes a platform, front and rear roller assemblies, a driveshaft, a plurality of resistance assemblies, and a controller. Each of the front and rear modular roller assemblies is adjustable along a length of the platform and is configured to receive a pair of wheels of the motor vehicle. The driveshaft is secured between the front roller assembly and the rear roller assembly and is configured to transmit rotary power from one of the front roller assembly and the rear roller assembly to the other of the front roller assembly and the rear roller assembly. The resistance assemblies are coupled to the front and rear roller assemblies and configured to vary a resistance of the front and rear roller assemblies. The controller is in communication with the plurality of resistance assemblies and configured to operate the plurality of resistance assemblies to vary the resistance of the front and rear roller assemblies. An orientation of the platform is adjustable.

In variations of the test apparatus of the above paragraph, which can be implemented individually or in any combination: the plurality of resistance assembles are secured to the platform; the plurality of resistance assemblies are located outside of the platform; each of the front roller assembly and the rear roller assembly includes first and second roller devices, each of the first and second roller devices configured to receive a respective wheel of the pair of wheels; an axle secured to and between the first and second roller devices; each of the first and second roller devices includes a first drum fixed for rotation with the axle; a second drum configured to be fixed for rotation with a drum axle; a transmission element meshingly engaged with the axle and configured to be meshingly engaged with the drum axle, the transmission element configured to transmit rotatory power from the first drum to the second drum; each resistance assembly of the plurality of resistance assemblies is engaged with the transmission element; a brake assembly associated with each of the first and second roller devices; the controller is configured to operate a first resistance assembly of the plurality of resistance assemblies at a first power output and a second resistance assembly of the plurality of resistance assemblies at a second power output, the first power output and the second power output are different; and the controller is configured to operate a first resistance assembly of the plurality of resistance assemblies at a first power output and a second resistance assembly of the plurality of resistance assemblies at a second power output, and wherein the first power output and the second power output are the same.

In yet another form, the present disclosure provides a test apparatus for simulating off-road conditions for a motor vehicle that includes a platform, front and rear roller assemblies, a driveshaft, and a plurality of resistance assemblies. Each of the front and rear roller assemblies is coupled to the platform and is configured to receive a pair of wheels of the motor vehicle. The driveshaft is secured between the front roller assembly and the rear roller assembly and is configured to transmit rotary power from one of the front roller assembly and the rear roller assembly to the other of the front roller assembly and the rear roller assembly. The resistance assemblies are coupled to the front and rear roller assemblies and configured to vary a resistance of the front and rear roller assemblies. An orientation of the platform is adjustable. Each of the front roller assembly and the rear roller assembly includes first and second roller devices. Each of the first and second roller devices is configured to receive a respective wheel of the pair of wheels and includes an axle, a first drum, a second drum, and a transmission element. The axle is secured to and between the first and second roller devices. The first drum is fixed for rotation with the axle. The second drum is configured to be fixed for rotation with a drum axle. The transmission element is meshingly engaged with the axle and configured to be meshingly engaged with the drum axle. The transmission element is configured to transmit rotatory power from the first drum to the second drum. Each resistance assembly of the plurality of resistance assemblies is engaged with the transmission element.

In yet another form, a method for simulating road conditions for a motor vehicle on a test apparatus includes disposing a pair of wheels of the motor vehicle on a roller assembly of the test apparatus, operating the motor vehicle such that the pair of wheels of the motor vehicle drive on the roller assembly, varying a resistance of the roller assembly such that a first wheel of the pair of wheels includes a first load and a second wheel of the pair of wheels includes a second load. The first load is different than the second load.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a test apparatus supporting a vehicle for simulating road conditions according to the principles of the present disclosure;

FIG. 2a is a perspective view of the test apparatus of FIG. 1 with the vehicle at a predetermined pitch;

FIG. 2b is a perspective view of the test apparatus of FIG. 1 with the vehicle at a predetermined roll;

FIG. 2c is a perspective view of the test apparatus of FIG. 1 with the vehicle at a predetermined yaw;

FIG. 3 is a perspective view of the test apparatus of FIG. 1 with the vehicle removed for clarity;

FIG. 4 is a schematic view of internal components of the test apparatus of FIG. 1;

FIG. 5 is a block diagram showing components of the test apparatus of FIG. 1; and

FIG. 6 is a flowchart depicting a method for simulating road conditions for a motor vehicle on a test apparatus according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

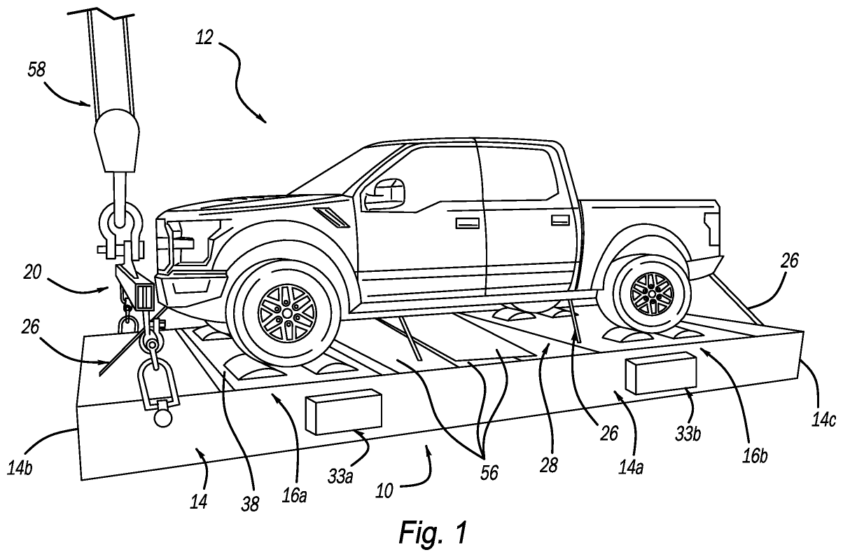

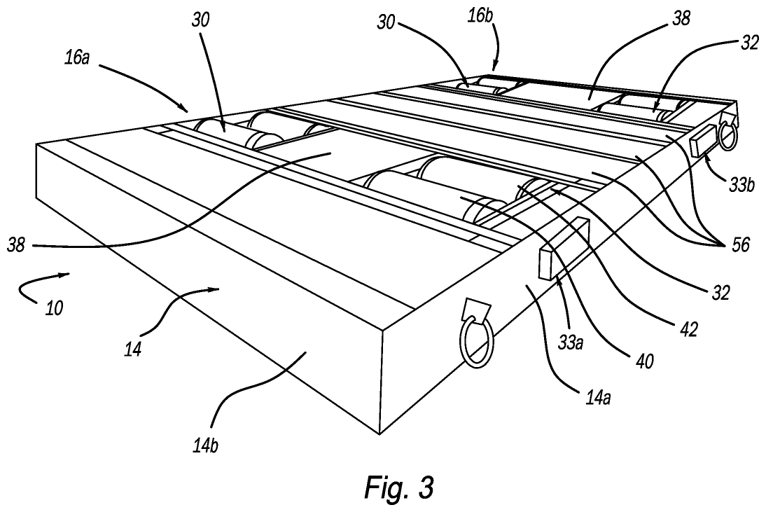

With reference to FIGS. 1-4, a test apparatus or test rig 10 for a vehicle 12 having first and second axles (not shown) is provided. The vehicle 12 may be a 2-wheel-drive vehicle (i.e., rear wheel drive (RWD) or a front wheel drive (FWD)) such that the first or primary axle includes first and second shafts (not shown) that drive a first set of wheels. In some configurations, the vehicle 12 may be a 4-wheel-drive (4WD) or all-wheel-drive (AWD) vehicle such that the second or secondary axle is also a drive axle and includes first and second shafts (not shown) that drive a second set of wheels. In other configurations, the vehicle 12 may be operable between a 2-wheel-drive mode in which first and second shafts (not shown) of a first axle (not shown) drive a first set of wheels, and a 4-wheel drive mode in which the first and second shafts of the first axle drive the first set of wheels and first and second shafts (not shown) of a second axle (not shown) drive a second set of wheels.

Generally, the test apparatus 10 simulates off-road conditions (pitch, roll, yaw, and combinations thereof as described in greater detail below), for example, for the vehicle 12. In the example illustrated, the test apparatus 10 is located within a building so as to provide privacy when simulating off-road conditions for the vehicle 12. Conducting such vehicle testing using the test apparatus 10 within the building also allows for repeatability of the testing due in part to the ability to control other testing conditions such as climate (e.g., temperature) within the building. In some forms, however, the test apparatus 10 is located outside (i.e., external to the building) when simulating off-road conditions for the vehicle 12. Although the vehicle 12 provided in FIG. 1 is a motor vehicle, it should be understood that the test apparatus 10 may simulate off-road conditions for electric vehicles such as battery electric vehicles (BEV), hybrid electric vehicles (HEV), plug-in electric vehicles (PHEV), or fuel cell vehicles, among others, for example.

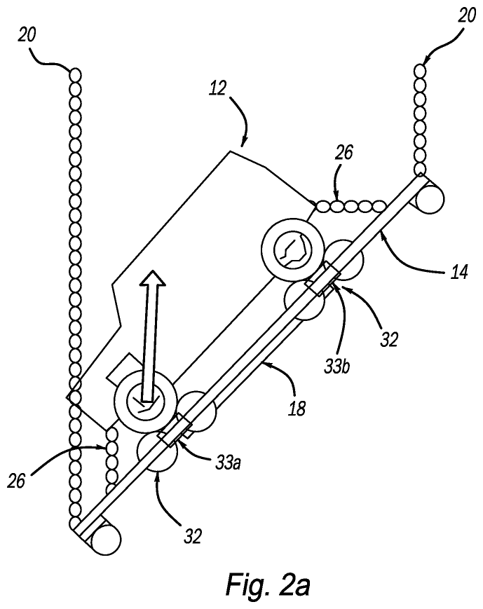

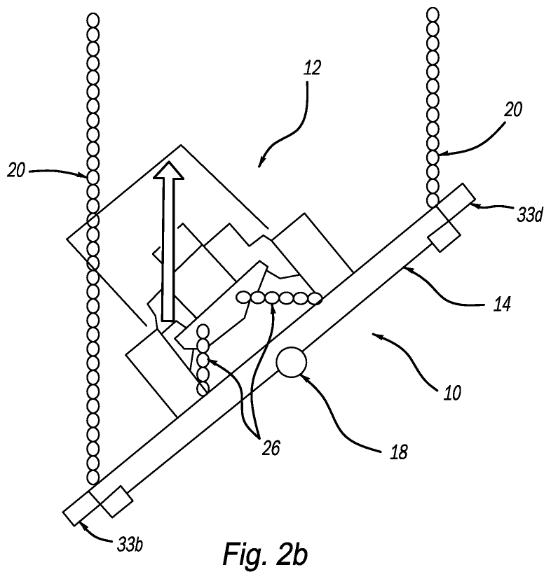

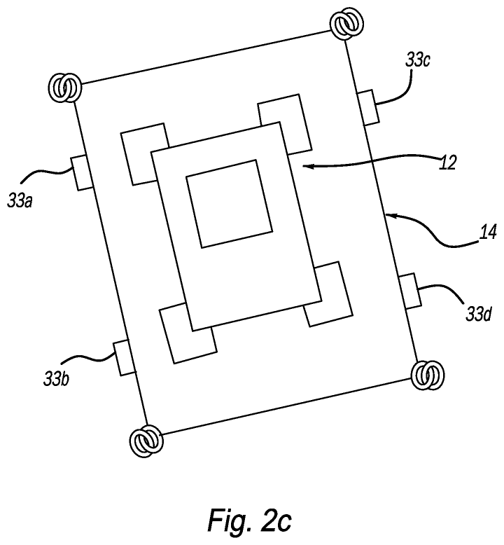

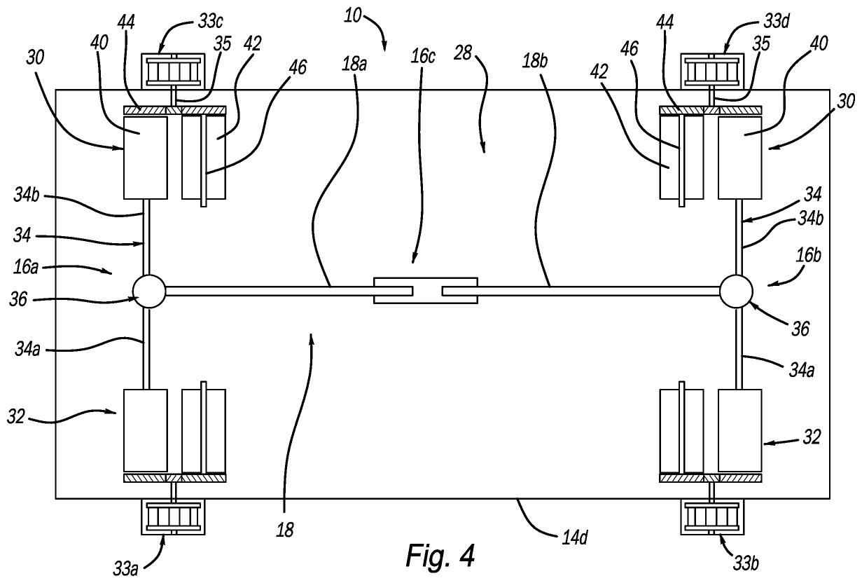

The test apparatus 10 includes a platform 14, a pair of roller assemblies 16a, 16b, a driveshaft 18 (FIG. 4), a plurality of suspension devices 20 (FIGS. 1 and 2a) and a plurality of tie-down devices 26 (FIGS. 1 and 2). In the example illustrated, the platform 14 is rectangular shape and made of a metal material. The platform 14 includes opposing side walls or beams 14a, a front wall or beam 14b, a back wall or beam 14c, and a bottom wall 14d (FIG. 4) that are secured to each other and that cooperate to define a cavity 28 (FIGS. 1 and 4). The driveshaft 18 is disposed within the cavity 28 (i.e., the driveshaft 18 is disposed entirely within the cavity 28) and the pair of roller assemblies 16a, 16b are at least partially disposed within the cavity 28. The opposing side walls 14a, the front wall 14b, the back wall 14c, and the bottom wall 14d are secured to each other via mechanical fasteners or any other suitable attachment means such as via welding, for example. In some forms, the bottom wall 14d comprises a plurality of individual plates that are removably secured to the side walls 14a, for example, which allow for easy removal and access to internal components of the test apparatus 10.

Each roller assembly 16a, 16b is modular and is configured to receive pairs of wheels of the vehicle 12. That is, each roller assembly 16a, 16b is removably secured to the platform 14 at different attachment points along a length of the platform 14 (i.e., each roller assembly 16a, 16b is adjusted along the length of the platform 14). In this way, the test apparatus 10 accommodates vehicles of different sizes. For example, when simulating off-road conditions for a pick-up truck, each roller assembly 16a, 16b may be located further away from each other (i.e., closer toward front and back walls 14b, 14c of the platform 14) compared to when simulating off-road conditions for a compact vehicle (e.g., sedan) where each roller assembly 16a, 16b may be located closer toward each other (i.e., closer towards a center of the platform 14). Additionally, the modular roller assemblies 16a, 16b allow for conveniently swapping out parts of the test apparatus 10 without the need to completely disassemble or replace the entire test apparatus 10.

Each roller assembly 16a, 16b includes first and second roller devices 30, 32, an axle 34 (FIG. 4), a differential 36 (FIG. 4), and a cover plate 38 (FIGS. 1-3). Each of the first and second roller devices 30, 32 are configured to receive a respective wheel of the pair of wheels and are located at or near opposing side walls 14a of the platform 14. When the vehicle 12 is a 4WD or AWD vehicle, for example, the drivetrain system of the vehicle 12 is allowed to disperse power to each of the first and second roller devices 30, 32 of the roller assemblies 16a, 16b independently. Each of the first and second roller devices 30, 32 includes a first or primary drum 40, a second or secondary drum 42, a transmission element 44 (FIG. 4), and a secondary drum axle 46 (FIG. 4). The first and second drums 40, 42 are partially disposed within the cavity 28 of the platform 14 and extend through a cut-out of a pair of cut-outs of the cover plate 38 such that portions of the first and second drums 40, 42 are located above the cover plate 38. The first drum 40 includes opposing end caps that are secured to the cover plate 38 via mechanical fasteners, for example. In this way, the end caps 50 rotatably support the first drum 40. The first drum 40 is splined to a respective shaft 34a, 34b of the axle 34 such that the first drum 40 is fixed for rotation with the respective shaft 34a, 34b. The first drum 40 also rotates about an axis of the respective shaft 34a, 34b. The second drum 42 includes opposing end caps that are secured to the cover plate 38 via mechanical fasteners, for example. In this way, the end caps 52 rotatably support the second drum 42. The second drum 42 is splined to the secondary drum axle 46 such that the second drum 42 is fixed for rotation with the secondary drum axle 46. The second drum 42 also rotates about an axis of the secondary drum axle 46. In some forms, each of the first and second drums 40, 42 and/or the axle 34 may include a resistance device or resistance assembly 33a, 33b, 33c, 33d such as an eddy current absorber. In this way, the drums 40, 42 and/or the axle 34 may change wheel loading conditions (i.e., create resistance to the rotation of the drums 40, 42).

The transmission element 44 is supported by and meshingly engaged with a hub (not shown) that is, in turn, meshingly engaged with the respective shaft 34a, 34b and the secondary drum axle 46. In this way, rotary power from the first drum 40 is transmitted to the second drum 42. The transmission element 44 may be a chain or a belt, for example, or any other suitable transmission means for transmitting rotatory power between objects. The secondary drum axle 46 is spaced apart from the axle 34 and extends parallel to the axle 34. In some forms, the transmission element 44 may be omitted such that the drum 42 rotates freely around the drum axle 46.

As shown in FIG. 4, the axle 34 is secured to and between the first drums 40 of the first and second roller devices 30, 32 and extends transverse to a longitudinal direction of the platform 14. In some forms, the axle 34 may be secured to and between the second drums 42 of the first and second roller devices 30, 32 instead of the first drums 40 and extends transverse to the longitudinal direction of the platform 14. The axle 34 includes the first shaft 34a that is secured to the first drum 40 of the first roller device 30 and the second shaft 34b that is secured to the first drum 40 of the second roller device 32.

With reference to FIGS. 1, 3, and 4, the resistance assemblies 33a, 33b, 33c, 33d are operable independently of each other as will be described in more detail below. The resistance assemblies 33a, 33b, 33c, 33d are located outside of the platform 14 and removably secured to the platform 14. In the example illustrated, the resistance assemblies 33a, 33b are removably secured to one of the side walls 14a and the resistance assemblies 33c, 33d are removably secured to the other of the side walls 14a. The resistance assemblies 33a, 33b, 33c, 33d may be secured to the platform 14 via mechanical fasteners (e.g., screws and/or bolts), clamps, mounting structures, or any other suitable attachments means such that the resistance assemblies 33a, 33b, 33c, 33d may be secured to different locations along the platform 14 based on the location of the roller assemblies 16a, 16b. In some forms, the resistance assemblies 33a, 33b, 33c, 33d are located outside of the platform 14 and secured to the bottom wall 14d. In some forms, the resistance assemblies 33a, 33b, 33c, 33d are located within the platform 14 (i.e., disposed within the cavity 28 of the platform 14) so as to be hidden from view outside the platform 14.

Each resistance assembly 33a, 33b, 33c, 33d is coupled to a respective roller device 30, 32. In the example illustrated, the resistance assembly 33a is coupled to the roller device 32 of the front roller assembly 16a, the resistance assembly 33b is coupled to the roller device 32 of the rear roller assembly 16b, the resistance assembly 33c is coupled to the roller device 30 of the front roller assembly 16a, and the resistance assembly 33d is coupled to the roller device 30 of the rear roller assembly 16b. More specifically, each resistance assembly 33a, 33b, 33c, 33d is coupled to the transmission element 44 of the respective roller device 30, 32. In this way, a desired resistance of the drums 40, 42 of the roller device 30, 32 may be achieved.

Each resistance assembly 33a, 33b, 33c, 33d may be an eddy current absorber that includes, inter alia, a rotor (not specifically shown) and an electromagnet (not specifically shown). The rotor is mounted to a coupling member 35 (e.g., a shaft) that is, in turn, connected to the transmission element 44 of the respective roller device 30, 32. The electromagnet is fixed to the platform 14 (e.g., the side walls 14a and/or the bottom wall 14d of the platform 14). Eddy currents are produced in the rotor due to a relative velocity difference between the rotor and the electromagnet, which generate a force changing the rotational speed of the rotor, thereby changing the resistance of the drums 40, 42 of the roller devices 30, 32.

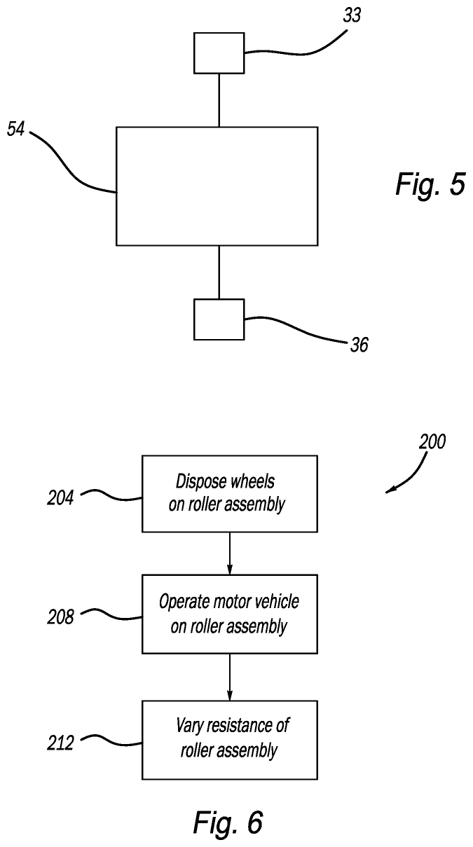

With reference to FIG. 5, the resistance assemblies 33 are in communication with a controller 54 such that the controller 54 is configured to operate the resistance assemblies 33 to vary or change the resistance of the front and rear roller assemblies 16a, 16b. In this way, the test apparatus 10 may simulate a vehicle traversing a pathway that includes different terrains, slopes, and/or objects, for example, that may adjust/change the conditions (pitch, roll, yaw, and combinations thereof) of the vehicle. Stated differently, pathways including different terrains, slopes, and/or objects may cause the wheels of the vehicle to be loaded differently. For example, a vehicle may traverse a pathway that includes an upward slope, which causes the rear wheels (and rear axle) to carry more load than the front wheels (and front axle). In another example, a vehicle may traverse a pathway that includes a negative slope, which causes the front wheels to carry more load than the rear wheels. In yet another example, a vehicle may traverse a pathway where the wheels are driving over objects causing one or more of the wheels (and respective half shaft) to carry more load than the other wheels (and half shafts). The test apparatus 10 of the present disclosure including the resistance assemblies 33 may allow simulation of such scenarios.

In some configurations, the test apparatus 10 may simulate off-road conditions where the vehicle 12 drives along a pathway including multiple loading conditions of the wheels at different points in time. In such conditions, the controller 54 may operate the resistance assemblies 33 to accurately simulate the off-road conditions. For example, the pathway driven may include a first loading condition where the rear wheels carry more load than the front wheels and a second loading condition where the front wheels carry more load than the rear wheels. In such example, the controller 54 manually or automatically may operate the resistance assemblies 33 for a first predetermined time period (e.g., 1 minute) such that the resistance assemblies 33b, 33d provide more resistance to the roller devices 30, 32 of the roller assembly 16b than the resistance assemblies 33a, 33c provide to the roller devices 30, 32 of the roller assembly 16a. Then, the controller 54 may operate the resistance assemblies 33 for a second predetermined time period (e.g., 1 minute) such that the resistance assemblies 33a, 33c provide more resistance to the roller devices 30, 32 of the roller assembly 16a than the resistance assemblies 33b, 33d provide to the roller devices 30, 32 of the roller assembly 16b.

In some configurations, the test apparatus 10 may include various modes that simulate off-road conditions that can be sudden and unpredictable. In such modes, the test apparatus can simulate a sudden slip (e.g., the one or more wheels driving over a loose rock, but quickly regaining traction) of one or more wheels of the vehicle along a pathway or a sudden grip of one or more wheels of the vehicle along the pathway. For example, the pathway driven may include a first loading condition where the rear wheels carry more load than the front wheels then simulates a sudden change where one or more of the rear wheels carries less load than the other rear wheels, for example, for a predetermined time period (e.g., 0.25 section—5 seconds) before returning to the first loading condition or a different loading condition (e.g., passenger side wheels carrying a different load than driver side wheels).

In another example, the pathway driven may include a first loading condition where the driver side wheels carry more load than the passenger side wheels and a second loading condition where the passenger side wheels carry more load than the driver side wheels. In such example, the controller 54 manually or automatically may operate the resistance assemblies 33 for a first predetermined time period (e.g., 1 minute) such that the resistance assemblies 33a, 33b provide more resistance to the roller devices 32 of the roller assemblies 16a, 16b than the resistance assemblies 33c, 33d provide to the roller devices 30 of the roller assemblies 16a, 16b. Then, the controller 54 may operate the resistance assemblies 33 for a second predetermined time period (e.g., 1 minute) such that the resistance assemblies 33c, 33d provide more resistance to the roller devices 32 of the roller assembly 16a, 16b than the resistance assemblies 33a, 33b provide to the roller devices 30 of the roller assembly 16a, 16b.

In another example, the pathway driven may include a first loading condition where one of the wheels of the vehicle carries more load than the other wheels of the vehicle and a second loading condition where all the wheels carry a different load. In such example, the controller 54 manually or automatically may operate the resistance assemblies 33 for a first predetermined time period (e.g., 1 minute) such that the resistance assembly 33a provides more resistance to the roller device 32 of the roller assembly 16a than the resistance assemblies 33c, 33d provide to the roller devices 30 of the roller assemblies 16a, 16b and the resistance assembly 33b provides to the roller device 32 of the roller assembly 16b. Then, the controller 54 may operate the resistance assemblies 33 for a second predetermined time period (e.g., 1 minute) such that the resistance assemblies 33a, 33b 33c, 33d provide different resistances to respective roller devices 30, 32 of the roller assembly 16a, 16b.

The differential 36 is operatively connected to the driveshaft 18 and the first and second shafts 34a, 34b of the axle 34, and allows the first and second shafts 34a, 34b to rotate at the same speed or at different speeds. The differential 36 may be any type of controllable differential such as an electronic limited slip differential that is in communication with the controller 54 (FIG. 5). The differential 36 is operable in a first differential mode in which the first shaft 34a and the second shaft 34b are allowed to rotate at different speeds, and a second differential mode in which the differential 36 inhibits relative rotation between the first shaft 34a and the second shaft 34b. For example, the first differential mode can be an open differential mode and the second differential mode can be a limited slip differential mode or a locked differential mode.

The differential 36 may be any suitable type of differential. In one form, the differential 36 has a planetary differential gearset and include, inter alia, a driveshaft (not shown), a housing (not shown), a ring gear (not shown), one or more planet gears (not shown), first and second side gears (not shown), and a clutch (not shown). The driveshaft connects to the driveshaft 18. An input gear (not shown) is connected to the driveshaft. The input gear is a separate component that is secured to the driveshaft or may be an integral part of the driveshaft. The input gear is configured to mesh with the ring gear. The planet gears is connected to the ring gear and meshes with the first and second side gears. The first side gear is connected to the first shaft 34a. The first side gear is a separate component that is secured to the first shaft 34a or may be an integral part of the first shaft 34a. The second side gear is connected to the second shaft 34b. The second side gear is a separate component that is secured to the second shaft 34b or may be an integral part of the second shaft 34b.

The clutch (not shown) can be any suitable type of clutch that is operable to selectively permit or inhibit relative rotation between the first and second shafts 34a, 34b. In one form, the clutch (not shown) includes a set of plates (not shown) associated with (e.g., secured to) the housing (not shown) and a set of discs (not shown) associated with (e.g., secured to) at least one of the first and second shafts 34a, 34b. When the set of plates and the set of discs are disengaged from each other, the differential 36 is in the first differential mode and acts as an open differential. When the set of plates and the set of discs are engaged with each other, the differential 36 is in the second differential mode and acts as a limited slip differential. It should be understood that although the differential 36 is described above as a clutch-type limited slip differential, the differential 36 may be other suitable differentials.

As shown in FIGS. 1-3, the cover plate 38 extends in a traverse direction relative to the longitudinal direction of the platform 14 and is removably secured to the opposing side walls 14a of the platform 14. The cover plate 38 covers or shields the axle 34, the differential 36, and portions of the first and second roller devices 30, 32 contained within the cavity 28 of the platform 14 from objects or fluids external to the cavity 28 during vehicle testing. The cover plate 38 includes the pair of cutouts that the first and second drums 40, 42 of the first and second roller devices 30, 32 extend through.

As shown in FIG. 4, the driveshaft 18 is disposed within the cavity 28 of the platform 14 and extends parallel to the longitudinal direction of the platform 14. The driveshaft 18 is secured between the pair of roller assemblies 16a, 16b and is configured to transmit rotary power from one of the pair of roller assemblies 16a, 16b to the other of the pair of roller assemblies 16a, 16b. For example, when the vehicle 12 is a RWD vehicle, the rear wheels causes rotation of the drums 40, 42 of the first and second roller devices 30, 32 of the roller assembly 16b, which, in turn, causes rotation of the drums 40, 42 of the first and second roller devices 30, 32 of the roller assembly 16a via the driveshaft 18, the differentials 36, and the axles 34. Rotation of the drums 40, 42 of the first and second roller devices 30, 32 of the roller assembly 16a drives the front wheels of the vehicle 12, therefore, accurately simulating off-road conditions of both sets of wheels of the RWD vehicle using the test rig 10. In some forms, each roller device 30, 32 of the roller assemblies 16a, 16b includes a braking assembly that is applied when the user or robot applies the brakes of the vehicle, thereby reducing the rotational speed of the drums 40, 42 of the roller devices 30, 32 of the roller assemblies 16a, 16b. The brake assembly may be a disc brake or a drum brake, for example.

The driveshaft 18 includes a first portion 18a connected to the differential 36 of the roller assembly 16a, a second portion 18b connected to the differential 36 of the roller assembly 16b, and a coupler 16c positioned between the first and second portions 18a, 18b. The coupler 16c may be a dog clutch, for example. The coupler 16c is movable between a first or engaged position in which the first and second portions 18a, 18b are fixed for rotation with each other, and a second or disengaged position in which the first and second portions 18a, 18b rotate relative to each other. For example, the coupler 16c is in the engaged position when the vehicle being tested is a 2-wheel-drive vehicle such that rotatory power from the drivable wheels are transmitted to the non-drivable wheels via the driveshaft 18. In another example, the coupler 16c is in the disengaged position when the vehicle being tested is a 4WD or AWD vehicle. The coupler 16c is movable between the first and second positions manually or automatically using the controller 54. One or more cover plates 56 (FIGS. 1-3) are removably secured to the platform 14, and cover or shield the driveshaft 18 contained within the cavity 28 of the platform 14 from objects or fluids external to the cavity 28 during vehicle testing.

As shown in FIGS. 1 and 2, each suspension device 20 is secured at a first end to a respective corner of the platform 14 (i.e., secured to an attachment feature such as a D-ring fixed to a respective side wall 14a of the platform 14) and at a second end to a lift 58. Although only two suspension devices 20 are shown secured at or near the front wall 14b of the platform 14 in FIGS. 1 and 2, the testing rig 10 may include four suspension devices, for example, secured to a respective corner of the four corners of the platform 14. The suspension devices 20 may be chains, cables, pulleys or a combination thereof. In some forms, the suspension devices may be any other suitable suspension means for suspending the platform 14 including the vehicle 12 partially or entirely above a ground surface.

In the example illustrated, the lift 58 is an overhead crane that operates to adjust an orientation of the platform 14 and the vehicle 12. For example, the lift 58 adjusts the orientation of the platform 14 such as the yaw, roll, pitch or combinations thereof. The pitch angle may be such that the fore end of the vehicle 12 is inclined at a 45-degree angle, for example, with respect to the ground surface (nose-up scenario). In another example, the pitch angle may be such that the aft end of the vehicle 12 is inclined at a 45-degree angle, for example, with respect to the ground surface (FIG. 2a; nose-down scenario). In another example, the roll angle may be such that a left or right side of the vehicle 12 is rolled at a predetermined angle, for example, with respect to the ground surface (FIG. 2b). The predetermined angle may be 40 degrees, for example. In yet another example, the vehicle 12 and platform 14 are oriented at a predetermined yaw (FIG. 2c). In some examples, the vehicle 12 and the platform 14 may be oriented with a pitch angle and a roll angle. That is, the vehicle 12 and the platform 14 are inclined at a 45-degree nose down scenario and a 10-degree roll angle.

As shown in FIGS. 1 and 2, the plurality of tie-down devices 26 are configured to secure the vehicle 12 to the platform 14. The tie-down devices 26 may be chains, cables, or any other suitable securement means for securing the vehicle 12 to the platform 14.

With reference to FIG. 6, a method 200 for simulating road conditions for the motor vehicle 12 is provided. In the example illustrated, the motor vehicle 12 is a 2-wheel-drive vehicle. In some forms, the vehicle 12 may be a four-wheel-drive vehicle or an all-wheel-drive vehicle. At 204, a front pair of wheels of the motor vehicle 12 is disposed on the roller assembly 16a and a rear pair of wheels of the motor vehicle 12 is disposed on the roller assembly 16b. At 208, the motor vehicle is in operation (i.e., driven) such that one of the front and rear pair of wheels drives on the respective roller assembly 16a, 16b thereby causing rotary power to be transmitted to the other of the front and rear pair of wheels via the driveshaft 18 of test apparatus 10. This, in turn, causes the other of the front and rear pair of wheels to roll on the respective roller assembly 16a, 16b.

At 212, a resistance of the roller devices 30, 32 of the roller assemblies 16a, 16b may be varied to load the front pair of wheels and the rear pair of wheels of the motor vehicle 12 among a plurality of loading conditions. For example, the roller devices 30, 32 of the roller assembly 16a, 16b may be varied in a first loading condition where one of the wheels of the vehicle carries more load than the other wheels of the vehicle and a second loading condition where all the wheels carry a different load. In such example, the controller 54 manually or automatically may operate the resistance assemblies 33 for a first predetermined time period (e.g., 1 minute) such that the resistance assembly 33a provides more resistance to the roller device 32 of the roller assembly 16a than the resistance assemblies 33c, 33d provide to the roller devices 30 of the roller assemblies 16a, 16b and the resistance assembly 33b provides to the roller device 32 of the roller assembly 16b. Then, the controller 54 may operate the resistance assemblies 33 for a second predetermined time period (e.g., 1 minute) such that the resistance assemblies 33a, 33b 33c, 33d provide different resistances to respective roller devices 30, 32 of the roller assembly 16a, 16b.

The testing rig 10 of the present disclosure provides the benefit of accurately simulating off-road conditions of the vehicle 12 at a plurality of operating conditions. In this way, engine oil pick-up, turbo oil injection, transmission oil pick-up, fuel pick-up, shift quality, and a variety of other vehicle operation conditions can all be tested.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A test apparatus for simulating off-road conditions for a motor vehicle, the test apparatus comprising:
a platform;
front and rear roller assemblies coupled to the platform, each of the front roller assembly and the rear roller assembly being configured to receive a pair of wheels of the motor vehicle;
a driveshaft secured between the front roller assembly and the rear roller assembly and configured to transmit rotary power from one of the front roller assembly and the rear roller assembly to the other of the front roller assembly and the rear roller assembly; and
at least one resistance assembly coupled to at least one of the front and rear roller assemblies and configured to vary a resistance of the at least one of the front and rear roller assemblies,
wherein an orientation of the platform is adjustable.

2. The test apparatus of claim 1, wherein the at least one resistance assembly is secured to the platform.

3. The test apparatus of claim 1, wherein the at least one resistance assembly is located outside of the platform.

4. The test apparatus of claim 1, wherein each of the front roller assembly and the rear roller assembly includes:
first and second roller devices, each of the first and second roller devices configured to receive a respective wheel of the pair of wheels; and
an axle secured to and between the first and second roller devices.

5. The test apparatus of claim 4, wherein each of the first and second roller devices includes:
a first drum fixed for rotation with the axle;
a second drum configured to be fixed for rotation with a drum axle; and
a transmission element meshingly engaged with the axle and configured to be meshingly engaged with the drum axle, the transmission element configured to transmit rotatory power from the first drum to the second drum.

6. The test apparatus of claim 5, wherein the at least one resistance assembly is engaged with the transmission element.

7. The test apparatus of claim 4, further comprising a brake assembly associated with each of the first and second roller devices.

8. The test apparatus of claim 1, wherein the orientation includes roll, pitch, yaw, and combinations thereof.

9. The test apparatus of claim 8, further comprising:
a crane; and
a plurality of suspension devices, each suspension device secured at a first end to a respective corner of the platform and at a second end to the crane,
wherein the crane is configured to adjust the orientation of the platform.

10. The test apparatus of claim 1, wherein the at least one resistance assembly includes a plurality of resistance assemblies, and wherein the plurality of resistance assemblies are operable independent of each other.

11. A test apparatus for simulating off-road conditions for a motor vehicle, the test apparatus comprising:
a platform;
front and rear roller assemblies coupled to the platform, each of the front modular roller assembly and the rear modular roller assembly is adjustable along a length of the platform and being configured to receive a pair of wheels of the motor vehicle;
a driveshaft secured between the front roller assembly and the rear roller assembly and configured to transmit rotary power from one of the front roller assembly and the rear roller assembly to the other of the front roller assembly and the rear roller assembly;
a plurality of resistance assemblies coupled to the front and rear roller assemblies and configured to vary a resistance of the front and rear roller assemblies; and
a controller in communication with the plurality of resistance assemblies and configured to operate the plurality of resistance assemblies to vary the resistance of the front and rear roller assemblies,
wherein an orientation of the platform is adjustable.

12. The test apparatus of claim 11, wherein the plurality of resistance assembles are secured to the platform.

13. The test apparatus of claim 11, wherein the plurality of resistance assemblies are located outside of the platform.

14. The test apparatus of claim 11, wherein each of the front roller assembly and the rear roller assembly includes:
first and second roller devices, each of the first and second roller devices configured to receive a respective wheel of the pair of wheels; and
an axle secured to and between the first and second roller devices.

15. The test apparatus of claim 14, wherein each of the first and second roller devices includes:
a first drum fixed for rotation with the axle;
a second drum configured to be fixed for rotation with a drum axle; and
a transmission element meshingly engaged with the axle and configured to be meshingly engaged with the drum axle, the transmission element configured to transmit rotatory power from the first drum to the second drum.

16. The test apparatus of claim 15, wherein each resistance assembly of the plurality of resistance assemblies is engaged with the transmission element.

17. The test apparatus of claim 14, further comprising a brake assembly associated with each of the first and second roller devices.

18. The test apparatus of claim 11, wherein the controller is configured to operate a first resistance assembly of the plurality of resistance assemblies at a first power output and a second resistance assembly of the plurality of resistance assemblies at a second power output, and wherein the first power output and the second power output are different.

19. The test apparatus of claim 11, wherein the controller is configured to operate a first resistance assembly of the plurality of resistance assemblies at a first power output and a second resistance assembly of the plurality of resistance assemblies at a second power output, and wherein the first power output and the second power output are the same.

20. A method for simulating road conditions for a motor vehicle, the method comprising:
disposing a pair of wheels of the motor vehicle on a roller assembly of a test apparatus;
operating the motor vehicle such that the pair of wheels of the motor vehicle drive on the roller assembly;
varying a resistance of the roller assembly such that a first wheel of the pair of wheels comprises a first load and a second wheel of the pair of wheels comprises a second load, the first load being different than the second load.
